(19) United States
(12) Patent Application Publication
(10) Pub. No.: US 2011/0208624 A1
(43) Pub. Date: Aug. 25, 2011

(54) PARKING FEE MANAGEMENT SUPPORTING SYSTEM AND PARKING FEE MANAGEMENT SUPPORTING METHOD

(75) Inventors: Mahina Nakamura, Tokyo (JP); Maki Sato, Kanagawa-ken (JP); Tsunehiro Motegi, Tokyo (JP); Naoki Hoshino, Saitama-ken (JP); Hiroshi Nishikawa, Shizuoka-ken (JP); Akihiro Souma, Shizuoka-ken (JP); Yusuke Minoura, Shizuoka-ken (JP)

(73) Assignee: TOSHIBA TEC KABUSHIKI KAISHA, Tokyo (JP)

(21) Appl. No.: 13/030,202

(22) Filed: Feb. 18, 2011

(30) Foreign Application Priority Data
Feb. 22, 2010 (JP) 2010-36490

(51) Int. Cl. G06Q 10/00

(52) U.S. Cl. 705/30

(57) ABSTRACT

According to one embodiment, a parking fee management supporting system supports parking fee management concerning a car park in which a free parking available period is granted according to a purchase amount in a predetermined store. The parking fee management supporting system calculates a free parking available remaining time in the car park in association with a user, who inquires about a remaining time of the free parking available period, on the basis of a parking start time and purchase information of the user.

### CROSS-REFERENCE TO RELATED APPLICATION

This application is based upon and claims the benefit of priority from Japanese Application No. 2010-36490, filed on Feb. 22, 2010; the entire contents of which are incorporated herein by reference.

### FIELD

Embodiments described herein relate generally to a technique for supporting management of a parking fee.

### BACKGROUND

In the past, a parking fee managing system is known in which a period for allowing a user to park a vehicle free of charge in a predetermined car park is granted according to a purchase amount in a predetermined store. In the parking fee managing system in the past, even if the user who parks the vehicle in the predetermined car park grasps how long a free parking period is left, in order to specifically know how long time more the user can park the vehicle free of charge, the user has to calculate the time on the basis of, for example, parking start time printed on a parking slip or the like and the present time.

### DESCRIPTION OF THE DRAWINGS

FIG. 1 is a diagram for explaining a schematic configuration of a parking fee management supporting system;

FIG. 2 is a functional block diagram for explaining the parking fee management supporting system;

FIG. 3 is a flowchart for explaining a flow of processing in the parking fee management supporting system;

FIG. 4 is a screen display example in any one of a 1F parking floor terminal, a 2F parking floor terminal, and a 3F parking floor terminal;

FIG. 5 is an operation screen example displayed on a touch panel display in a self-order terminal;

FIG. 6 is a diagram of a screen example in which, together with an image area indicating a parking position of a vehicle of a user, it is displayed how long time more the user can park the vehicle free of charge;

FIG. 7 is an order screen example displayed on the touch panel display in the self-order terminal; and

FIG. 8 is a diagram of a screen example indicating that a free parking available period is granted as a result of a commodity purchase in a store.

### DETAILED DESCRIPTION

In general, according to one embodiment, a parking fee management supporting system is a parking fee management supporting system that supports parking fee management concerning a car park in which a free parking available period is granted according to a purchase amount in a predetermined store, the system including: an identification-information acquiring unit configured to acquire identification information of a user who parks a vehicle in the car park; a parking-time-storage control unit configured to cause the system to store, in a predetermined storage area, parking start time in the car park by the user, whose identification information is acquired by the identification-information acquiring unit, in association with the identification information of the user; a purchase-information-storage control unit configured to cause the system to store, in the predetermined storage area, purchase information concerning the purchase amount in the predetermined store by the user, whose identification information is acquired by the identification-information acquiring unit, in association with the identification information of the user; an inquiring-user identifying unit configured to acquire identification information of a user who inquires about a remaining time of the free parking available period concerning the car park; a remaining-time calculating unit configured to calculate a free parking available remaining time in the car park in association with the user, whose identification information is acquired by the inquiring-user identifying unit, on the basis of the parking start time caused to be stored by the parking-time-storage control unit and the purchase information caused to be stored by the purchase-information-storage control unit; and a notification control unit configured to cause the system to notify the user, whose identification information is acquired by the inquiring-user identifying unit, of the free parking available remaining time calculated by the remaining-time calculating unit.

In general, according to another embodiment, a parking fee management supporting method is a parking fee management supporting method in a parking fee managing system concerning a car park in which a free parking available period is granted according to a purchase amount in a predetermined store, the method including: acquiring identification information of a user who parks a vehicle in the car park; causing the parking fee managing system to store, in a predetermined storage area, parking start time in the car park by the user, whose identification information is acquired, in association with the identification information of the user; causing the parking fee managing system to store, in the predetermined storage area, purchase information concerning the purchase amount in the predetermined store by the user, whose identification information is acquired, in association with the identification information of the user; acquiring identification information of an inquiring user who inquires about a remaining time of the free parking available period concerning the car park; calculating a free parking available remaining time in the car park in association with the inquiring user, whose identification information is acquired, on the basis of the parking start time caused to be stored in the predetermined storage area and the purchase information caused to be stored in the predetermined storage area; and causing the parking fee managing system to notify the inquiring user, whose identification information is acquired, of the calculated free parking available remaining time.

An embodiment is explained below with reference to the accompanying drawings.

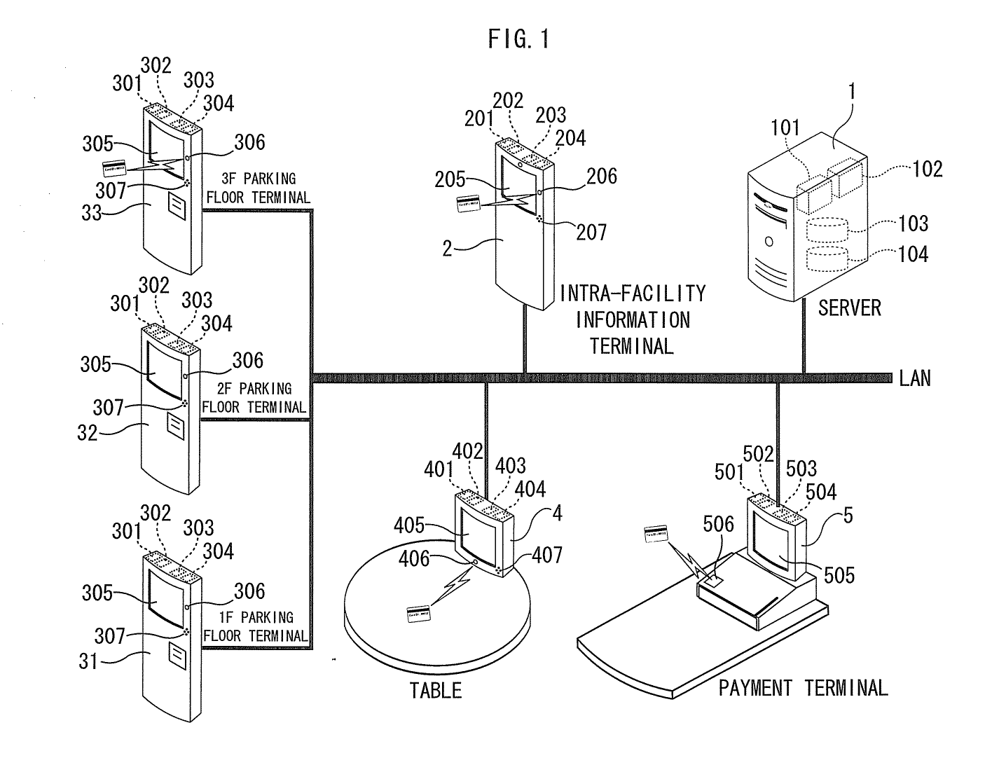

FIG. 1 is a diagram for explaining a schematic configuration of a parking fee management supporting system.

The parking fee management supporting system according to this embodiment is applied to a complex facility that adopts a service for charging, for example, according to a commodity purchase amount in a predetermined store (e.g., a store serving food and drink or a clothing store), no parking fee for a parking facility arranged adjacent to the store for a predetermined period. A “free parking available period”, which is a period in which a user can park a vehicle in the parking facility free of charge, is extended by a “predetermined additional free period” if a purchase amount in the predetermined store during the free parking available period satisfies a predetermined condition. In this embodiment, the parking facility arranged adjacent to the store includes three floors (1F, 2F, and 3F). In this embodiment, a user who parks a vehicle in the parking facility pays a parking fee in a parking fee adjustment machine (not shown) provided near the exit of the parking facility.

As shown in the figure, the parking fee management supporting system according to this embodiment includes, for example, a server 1, an intra-facility information terminal 2, a 1F parking floor terminal 31, a 2F parking floor terminal 32, a 3F parking floor terminal 33, a self-order terminal 4, and a payment terminal 5. The server 1, the intra-facility information terminal 2, the 1F parking floor terminal 31, the 2F parking floor terminal 32, the 3F parking floor terminal 33, the self-order terminal 4, and the payment terminal 5 can communicate with one another via an electric communication line such as a LAN. The communication among the apparatuses via the electric communication line may be realized either by wire communication or wireless communication.

The server 1 may be located in any place as long as the server 1 can resultantly communicate with the intra-facility information terminal 2, the 1F parking floor terminal 31, the 2F parking floor terminal 32, the 3F parking floor terminal 33, the self-order terminal 4, and the payment terminal 5.

The server 1 includes, for example, a CPU 101, an ASIC (Application Specific Integrated Circuit) 102, a memory 103, and a HDD (Hard Disk Drive) 104. The server 1 performs, for example, management of various data treated on the parking fee management supporting system according to this embodiment and management of authentication or the like during login of a user to the parking fee management supporting system.

The intra-facility information terminal 2 (equivalent to a notifying apparatus and a second identification information acquiring apparatus) is arranged in the complex facility (or the predetermined store) or around the complex facility (or near the predetermined store). The intra-facility information terminal 2 acquires identification information of a user who inquires about a remaining time of a free parking available period concerning a car park. The intra-facility information terminal 2 passes the identification information to an inquiring-user identifying unit 105.

The intra-facility information terminal 2 includes a CPU 201, an ASIC (Application Specific Integrated Circuit) 202, a memory 203, a HDD (Hard Disk Drive) 204, a touch panel display 205, a card reader 206, and a speaker 207. The 1F parking floor terminal 31 is set near a 1F gate of the parking facility, the 2F parking floor terminal 32 is set near a 2F gate of the parking facility, and the 3F parking floor terminal 33 is set near a 3F gate of the parking facility. The 1F parking floor terminal 31, the 2F parking floor terminal 32, and the 3F parking floor terminal 33 are equivalent to the notifying apparatus and a first identification information acquiring apparatus. The 1F parking floor terminal 31, the 2F parking floor terminal 32, and the 3F parking floor terminal 33 acquire identification information of a user, who parks a vehicle in the car park, and pass the identification information to an identification-information acquiring unit 101.

Each of the 1F parking floor terminal 31, the 2F parking floor terminal 32, and the 3F parking floor terminal 33 includes a CPU 301, an ASIC (Application Specific Integrated Circuit) 302, a memory 303, a HDD (Hard Disk Drive) 304, a touch panel display 305, a card reader 306, and a speaker 307.

The self-order terminal 4 (equivalent to the notifying apparatus) is individually arranged, for eating and drinking of food and drink purchased in a store serving food and drink in the complex facility, in a table or a predetermined order space arranged in the complex facility. For convenience of explanation, as an example, only one self-order terminal 4 is set. However, usually, plural self-order terminals 4 are arranged.

The self-order terminal 4 includes a CPU 401, an ASIC (Application Specific Integrated Circuit) 402, a memory 403, a HDD (Hard Disk Drive) 404, a touch panel display 405, a card reader 406, and a speaker 407.

The payment terminal 5 (equivalent to the notifying apparatus) is arranged in each of plural stores in the complex facility and processes payment of charges in the store.

The payment terminal 5 includes a CPU 501, an ASIC (Application Specific Integrated Circuit) 502, a memory 503, a HDD (Hard Disk Drive) 504, a touch panel display 505, and a card reader 506.

In the parking fee management supporting system according to this embodiment, the CPU 101, the CPU 201, the CPU 301, the CPU 401, and the CPU 501 have roles of performing various kinds of processing in the parking fee management supporting system. The CPU 101, the CPU 201, the CPU 301, the CPU 401, and the CPU 501 also have roles of realizing various functions by executing computer programs stored in the memory 103, the memory 203, the memory 303, the memory 403, the memory 503, the HDD 104, the HDD 204, the HDD 304, the HDD 404, the HDD 504, and the like. It goes without saying that the CPU 101, the CPU 201, the CPU 301, the CPU 401, and the CPU 501 can be substituted by MPUs (Micro Processing Units) that can execute the same arithmetic processing. The HDD 104, the HDD 204, the HDD 304, the HDD 404, and the HDD 504 can also be substituted by storage devices such as flash memories.

The memory 103, the memory 203, the memory 303, the memory 403, and the memory 503 can include, for example, RAMs (Random Access Memories), ROMs (Read Only Memories), DRAMs (Dynamic Random Access Memories), SRAMs (Static Random Access Memories), VRAMs (Video RAMs), or flash memories. The memory 103, the memory 203, the memory 303, the memory 403, and the memory 503 have roles of storing various kinds of information and computer programs used in the parking fee management supporting system.

It goes without saying that any one of the functions of the touch panel displays 105, 205, 305, 405, and 505 can be substituted by a display including, for example, electronic paper, an LCD (Liquid crystal display), an EL (Electronic Luminescence), a PDP (Plasma Display Panel), or a CRT (Cathode Ray tube) and an operation input unit including, for example, a keyboard, a mouse, a touch panel, a touchpad, a graphics tablet, or a dedicated button.

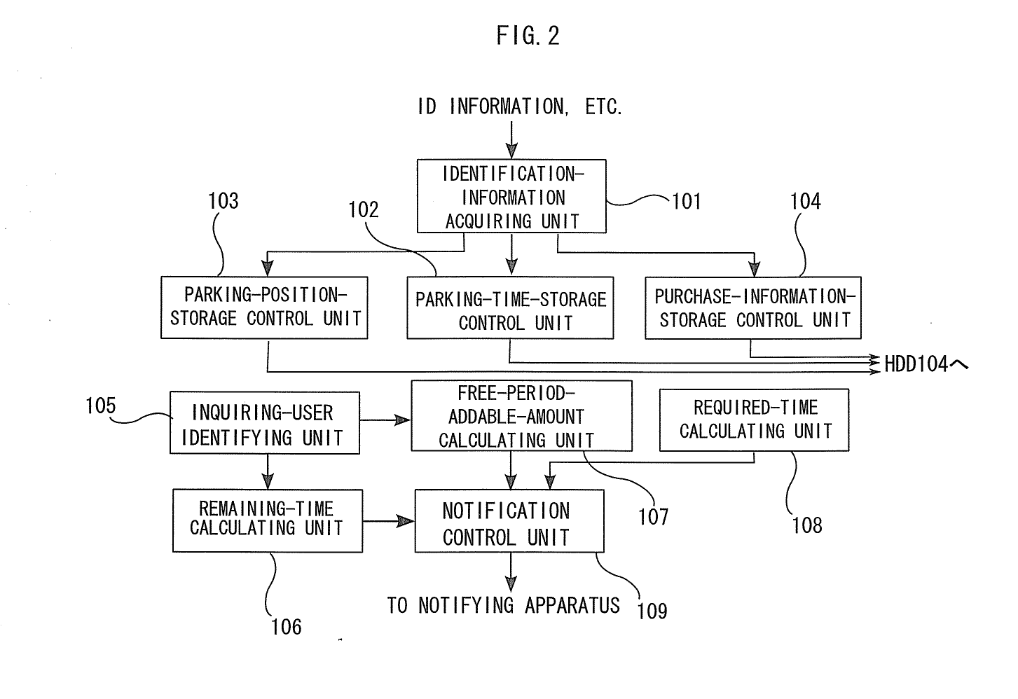

FIG. 2 is a functional block diagram for explaining the parking fee management supporting system.

As shown in the figure, the parking fee management supporting system includes, for example, the identification-information acquiring unit 101, a parking-time-storage control unit 102, a parking-position-storage control unit 103, a purchase-information-storage control unit 104, the inquiring-user identifying unit 105, a remaining-time calculating unit 106, a free-period-addable-amount calculating unit 107, a required-time calculating unit 108, and a notification control unit 109.

The identification-information acquiring unit 101 acquires identification information of a user who parks a vehicle in the car park.

The acquisition of the identification information can be realized by electrically reading, with a reader, a card or the like incorporating a wireless communication tag carried by the user or can be realized by optically reading, with a CCD camera or the like, a barcode or the like printed on a card.

The parking-time-storage control unit 102 causes the parking fee management supporting system to store parking start time in the car park by the user, whose identification information is acquired by the identification-information acquiring unit 101, in, for example, the HDD 104 (a predetermined storage area) in association with the identification information of the user.

The parking-position-storage control unit 103 causes the parking fee management supporting system to store a parking position of the parking in the car park by the user, whose identification information is acquired by the identification-information acquiring unit 101, in the HDD 104 (the predetermined storage area) in association with the identification information of the user.

The purchase-information-storage control unit 104 causes the parking fee management supporting system to store purchase information concerning a purchase amount in a predetermined store by the user, whose identification information is acquired by the identification-information acquiring unit 101, in the HDD 104 (the predetermined storage area) in association with the identification information of the user.

The inquiring-user identifying unit 105 acquires identification information of a user who inquires about a remaining time of the free parking available period concerning the car park.

The remaining-time calculating unit 106 calculates a free parking available remaining time in the car park in association with the user, whose identification information is acquired by the inquiring-user identifying unit 105, on the basis of the parking start time caused to be stored in the HDD 104 by the parking-time-storage control unit 102 and the purchase information caused to be stored in the HDD 104 by the purchase-information-storage control unit 104.

The free-period-addable-amount calculating unit 107 calculates, on the basis of at least the purchase information (a history of purchase amounts, etc.) caused to be stored in the HDD 104 by the purchase-information-storage control unit 104, an additional purchase amount necessary for obtaining a predetermined additional free period.

The required-time calculating unit 108 calculates time required for movement from the intra-facility information terminal 2, which acquires the identification informatibn of the inquiring user, to a parking fee adjustment machine (not shown) corresponding to any one (first identification-information acquiring apparatus) of the 1F parking floor terminal 31, the 2F parking floor terminal 32, and the 3F parking floor terminal 33 that acquires the identification information of the user, whose identification information is acquired by the intra-facility information terminal 2, during the parking. For the calculation of the moving time, for example, a data table in which predetermined values are stored may be used according to a combination of a terminal and a parking fee adjustment machine. The data table can be stored in the HDD 104 or the like.

The notification control unit 109 causes any one of the intra-facility information terminal 2, the self-order terminal 4, and the payment terminal 5 serving as the notifying apparatus to notify the user, whose identification information is acquired by the inquiring-user identifying unit 105, of, for example, (1) the free parking available remaining time calculated by the remaining-time calculating unit 106, (2) the additional purchase amount calculated by the free-period-addable-amount calculating unit 107, (3) the required time calculated by the required-time calculating unit 108, and (4) the parking position caused to be stored by the parking-position-storage control unit 103. When the notification control unit 109 causes the notifying unit to perform the notification, it goes without saying that the notification does not necessarily be performed by screen display and can also be performed by sound using, for example, a speaker included in the terminal.

The identification-information acquiring unit 101, the parking-time-storage control unit 102, and the parking-position-storage control unit 103 are desirably included in, for example, any one of the 1F parking floor terminal 31 to the 3F parking floor terminal 33. The purchase-information-storage control unit 104 is desirably included in, for example, the payment terminal 5. The inquiring-user identifying unit 105 is desirably included in, for example, the intra-facility information terminal 2. The remaining-time calculating unit 106, the free-period-addable-amount calculating unit 107, the required-time calculating unit 108, and the notification control unit 109 are desirably provided in the server 1.

It goes without saying that the arrangement of the functions is only an example and is not always limited to this. In other words, the functions may be arranged in any one of the 1F parking floor terminal 31 to the 3F parking floor terminal 33, the intra-facility information terminal 2, and the payment terminal 5 as long as the functions can cooperate with one another in a state in which functions resultantly required in the system as a whole are displayed.

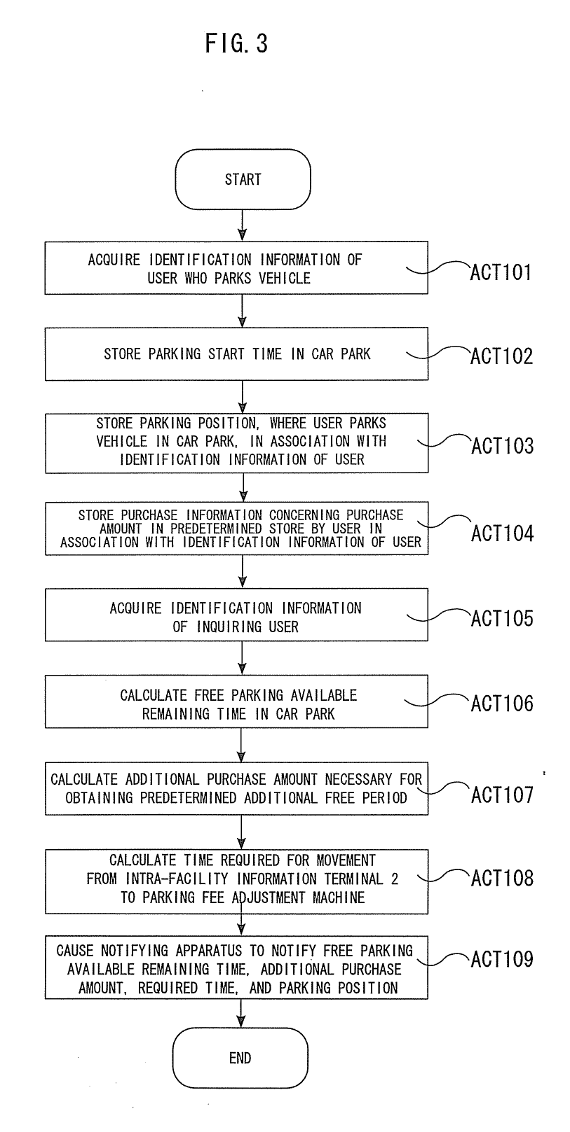

FIG. 3 is a flowchart for explaining a flow of processing in the parking fee management supporting system.

The identification-information acquiring unit 101 acquires identification information of a user who parks a vehicle in the car park (ACT 101).

The parking-time-storage control unit 102 causes the parking fee management supporting system to store parking start time in the car park by the user, whose identification information is acquired by the identification-information acquiring unit 101, in, for example, the HDD 104 in association with the identification information of the user (ACT 102).

The parking-position-storage control unit 103 causes the parking fee management supporting system to store a parking position of the parking in the car park by the user, whose identification information is acquired by the identification-information acquiring unit 101, in, for example, the HDD 104 in association with the identification information of the user (ACT 103).

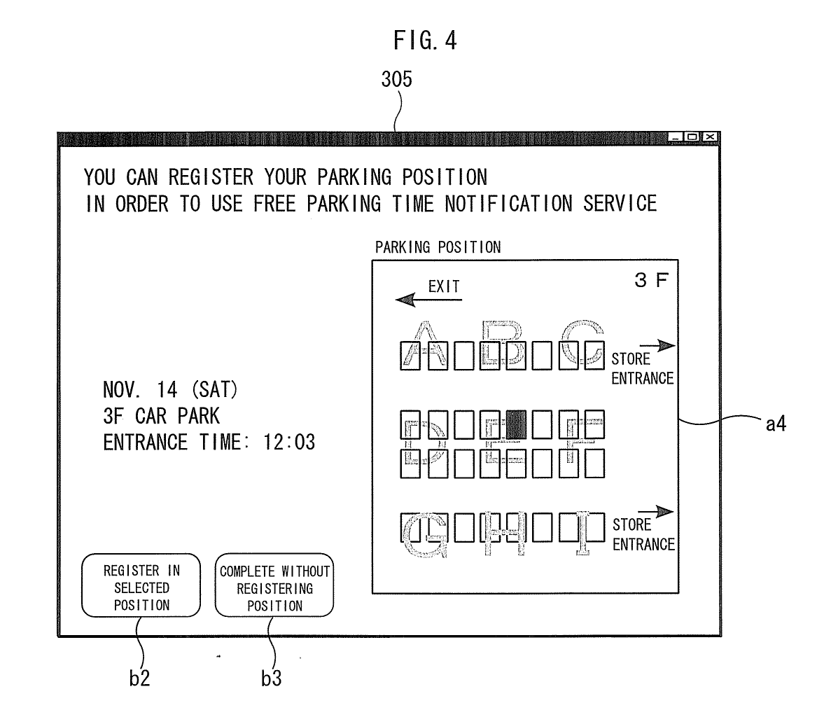

FIG. 4 is a screen display example in any one of the 1F parking floor terminal 31, the 2F parking floor terminal 32, and the 3F parking floor terminal 33. As shown in FIG. 4, when the user starts parking in the parking facility according to this embodiment, the user can register a parking position of the vehicle of the user. In FIG. 4, an area a4 is a selection screen for specifying a parking position, a button b2 is a button for performing registration in the selected parking position, and a button b3 is a button for ending the screen shown in FIG. 4 without registering the parking position.

The purchase-information-storage control unit 104 causes the parking fee management supporting system to store purchase information concerning a purchase amount in a predetermined store by the user, whose identification information is acquired by the identification-information acquiring unit 101, in, for example, the HDD 104 in association with the identification information of the user (ACT 104).

The inquiring-user identifying unit 105 acquires identification information of a user who inquires about a remaining time of the free parking available period concerning the car park (ACT 105).

The remaining-time calculating unit 106 calculates a free parking available remaining time in the car park in association with the user, whose identification information is acquired by the inquiring-user identifying unit 105, on the basis of the parking start time caused to be stored in the HDD 104 by the parking-time-storage control unit 102 and the purchase information caused to be stored in the HDD 104 by the purchase-information-storage control unit 104 (ACT 106).

The free-period-addable-amount calculating unit 107 calculates, on the basis of at least the purchase information caused to be stored in the HDD 104 by the purchase-information-storage control unit 104, an additional purchase amount necessary for obtaining a predetermined additional free period (ACT 107).

The required-time calculating unit 108 calculates time required for movement from the intra-facility information terminal 2, which acquires the identification information of the inquiring user, to a parking fee adjustment machine (not shown) corresponding to any one (first identification-information acquiring apparatus) of the 1F parking floor terminal 31, the 2F parking floor terminal 32, and the 3F parking floor terminal 33 that acquires the identification information of the user, whose identification information is acquired by the intra-facility information terminal 2, during the parking (ACT 108).

The notification control unit 109 causes any one of the intra-facility information terminal 2, the self-order terminal 4, and the payment terminal 5 serving as the notifying apparatus to notify the user, whose identification information is acquired by the inquiring-user identifying unit 105, of, for example, (1) the free parking available remaining time calculated by the remaining-time calculating unit 106, (2) the additional purchase amount calculated by the free-period-addable-amount calculating unit 107, (3) the required time calculated by the required-time calculating unit 108, and (4) the parking position caused to be stored by the parking-position-storage control unit 103 (ACT 109).

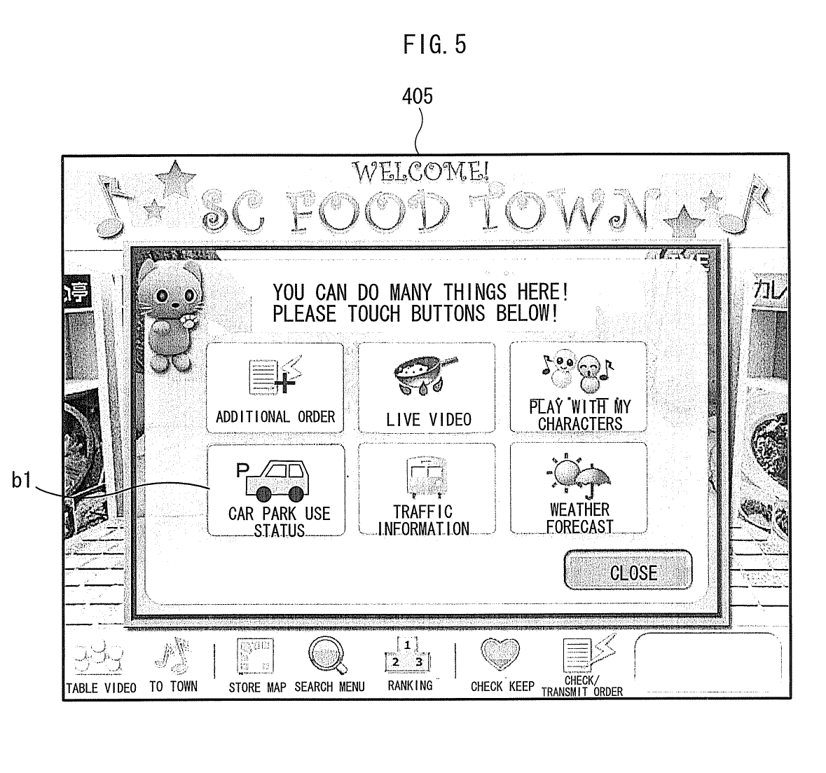

FIG. 5 is an operation screen example displayed on the touch panel display 405 in the self-order terminal 4. The screen is displayed in a state in which the user logs in.

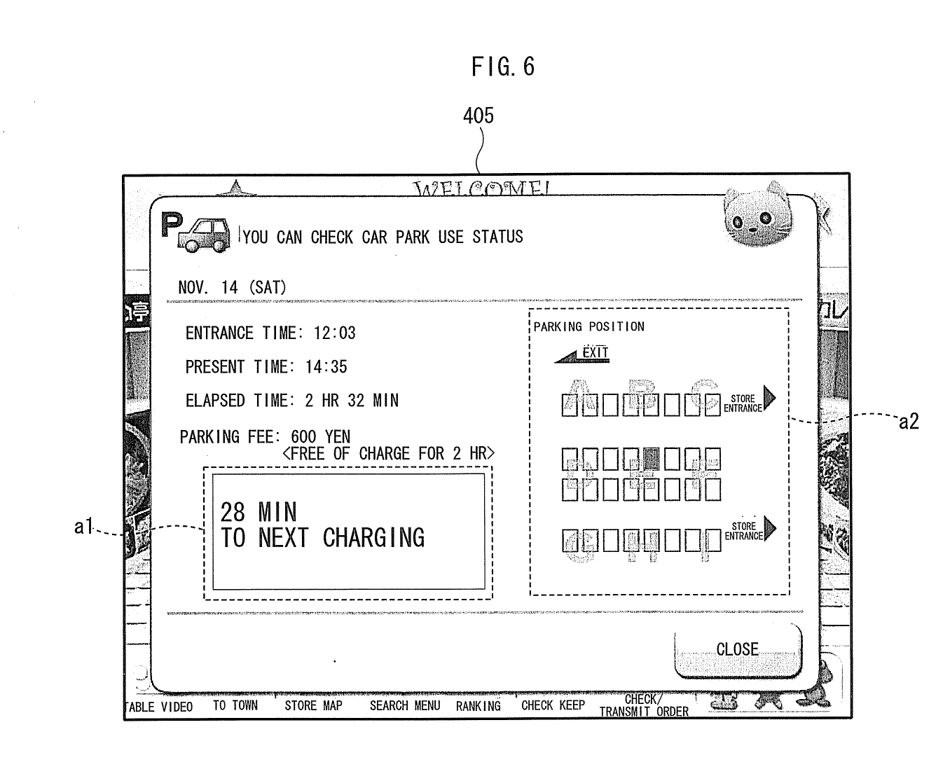

For example, when the user is eating and drinking on a table in the complex facility, if the user desires to know how long time more the user can park a vehicle free of charge, the user presses a button b1 on the screen. Then, a display screen transitions to contents shown in FIG. 6. In FIG. 6, together with an image area a2 indicating the parking position of the vehicle of the user registered in ACT 103, it is displayed how long time more the user can park the vehicle free of charge (an area a1).

It goes without saying that the check of such a free parking available remaining period can be performed not only in the self-order terminal 4 set in the table but also in the intra-facility information terminal 2 and the payment terminal 5 in the same manner on condition that the user logs in to the terminals.

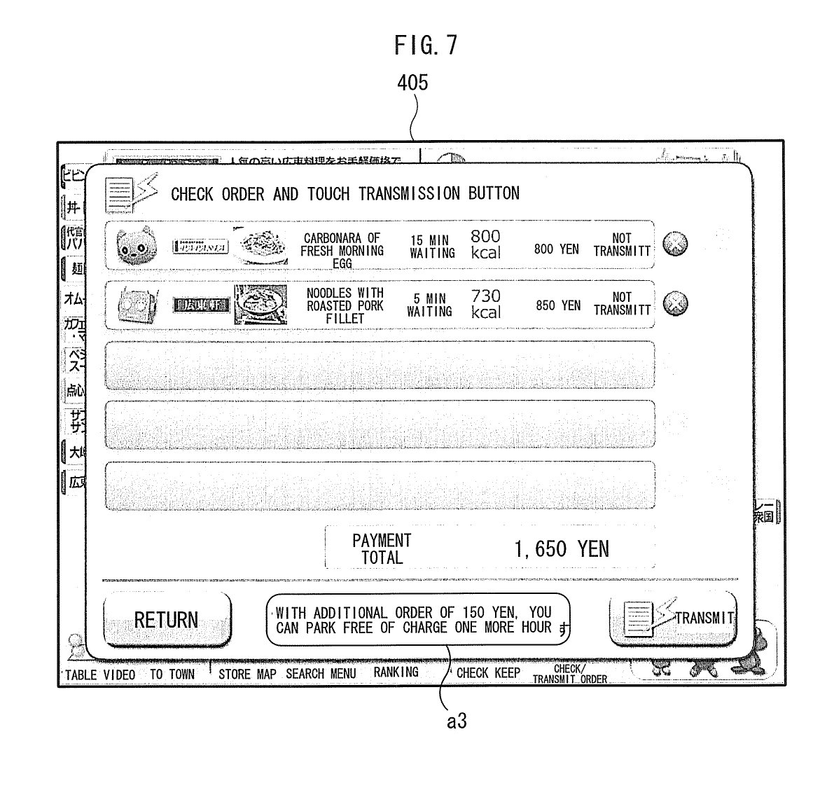

FIG. 7 is an order screen example displayed on the touch panel display 405 in the self-order terminal 4. As in the parking fee management supporting system according to this embodiment, if a free parking period is granted according to a purchase amount in a store, in some case, if the free parking period increases if only the user purchases a small amount more, the user desires to acquire the free parking period by paying the shortage.

Therefore, as shown in FIG. 7, it is visually and plainly displayed on the order screen how much more should be added to a total amount of order contents at that point to have an additional free parking period granted (an area a3). In this way, improvement of convenience for the user is realized.

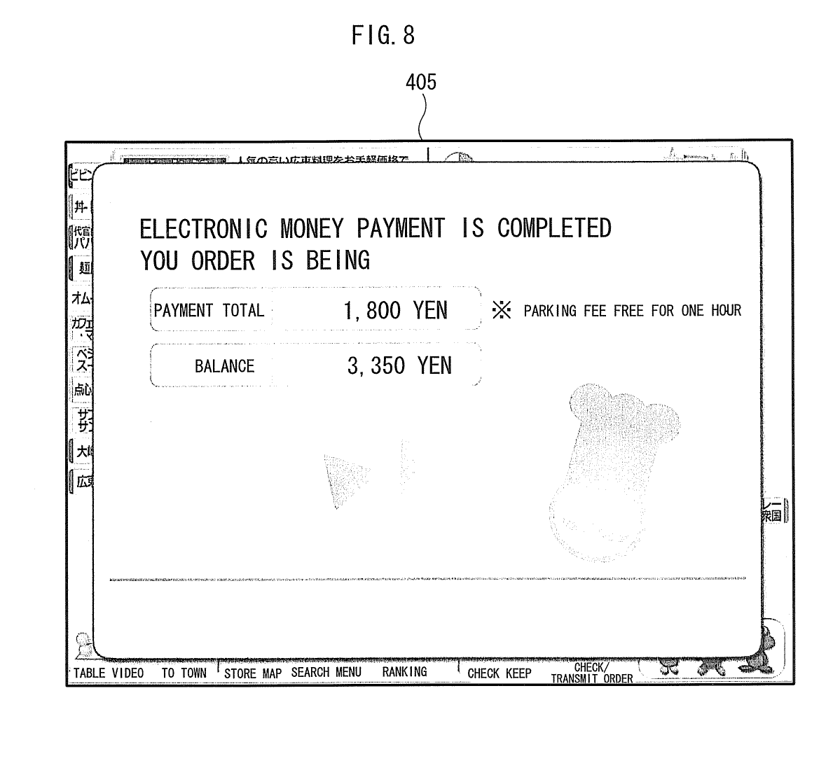

Further, if the free parking available period is granted as a result of commodity purchase in a store, as shown in FIG. 8, it is clearly displayed on the screen that the free parking available period is granted. This makes it possible to confirm that a parking fee discount service is applied according to a purchasing act and makes it possible to provide a standard for determining the remainder of the free parking available period of the user.

The operations in the processing in the parking fee management supporting system are realized by causing at least any one of the CPU 101, the CPU 201, the CPU 301, the CPU 401, and the CPU 501 to execute an order supporting program stored in at least any one of the memory 103, the memory 203, the memory 303, the memory 403, the memory 503, the HDD 104, the HDD 204, the HDD 304, the HDD 404, and the HDD 504.

Further, a computer program for causing a processor such as a CPU 801 (or an MPU or the like that can substitute the CPU 801) included in the parking fee management supporting system to execute the operations can be provided as a control parameter correcting method program. In the example explained in this embodiment, the computer program for realizing a function of carrying out the invention is recorded in advance in a storage area provided on the inside of an apparatus. However, the present invention is not limited to this. The same computer program may be downloaded from a network to the apparatus. The same computer program stored in a computer-readable recording medium may be installed in the apparatus. A form of the recording medium may be any form as long as the recording medium is a recording medium that can store the computer program and can be read by a computer. Specifically, examples of the recording medium include an internal storage device implemented on the inside of the computer such as a ROM or a RAM, a portable storage medium such as a CD-ROM, a flexible disk, a DVD disk, a magneto-optical disk, or an IC card, a database that stores a computer program, other computers and databases therefor, and a transmission medium on a line. Functions obtained by the installation or the download in advance in this way may be functions that cause an OS (operating system) or the like on the inside of an apparatus to realize the functions in cooperation with the OS or the like.

The computer program may be an execution module that is dynamically generated partially or entirely.

It goes without saying that it is also possible to cause an ASIC 802 to execute, in terms of a circuit, at least a part of the various kinds of processing realized by causing the CPU or the MPU to execute the computer program in the embodiment.

As explained above in detail, according to the technique described in this specification, it is possible to provide a technique for supporting management of a parkihg fee. In particular, according to the technique described in this specification, it is possible to provide a technique for allowing a user to easily check how long time of a free parking available period of the user remains in a system in which a free parking available period in a predetermined car park is granted according to a purchase amount in a predetermined store.

While certain embodiments have been described, these embodiments have been presented by way of example only, and are not intended to limit the scope of invention. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A parking fee management supporting system that supports parking fee management concerning a car park in which a free parking available period is granted according to a purchase amount in a predetermined store, the system comprising:
an identification-information acquiring unit configured to acquire identification information of a user who parks a vehicle in the car park;
a parking-time-storage control unit configured to cause the system to store, in a predetermined storage area, parking start time in the car park by the user, whose identification information is acquired by the identification-information acquiring unit, in association with the identification information of the user;
a purchase-information-storage control unit configured to cause the system to store, in the predetermined storage area, purchase information concerning the purchase amount in the predetermined store by the user, whose identification information is acquired by the identification-information acquiring unit, in association with the identification information of the user;
an inquiring-user identifying unit configured to acquire identification information of a user who inquires about a remaining time of the free parking available period concerning the car park;
a remaining-time calculating unit configured to calculate a free parking available remaining time in the car park in association with the user, whose identification information is acquired by the inquiring-user identifying unit, on the basis of the parking start time caused to be stored by the parking-time-storage control unit and the purchase information caused to be stored by the purchase-information-storage control unit; and
a notification control unit configured to cause the system to notify the user, whose identification information is acquired by the inquiring-user identifying unit, of the free parking available remaining time calculated by the remaining-time calculating unit.

2. The system according to claim 1, wherein
the free parking available period is extended by a predetermined additional free period if the purchase amount in the predetermined store during the free parking available period satisfies a predetermined condition,
the system further comprises a free-period-addable-amount calculating unit configured to calculate, on the basis of at least the purchase information caused to be stored by the purchase-information-storage control unit, an additional purchase amount necessary for obtaining the predetermined additional free period, and
the notification control unit causes the system to notify the user, whose identification information is acquired by the inquiring-user identifying unit, of the additional purchase amount calculated by the free-period-addable-amount calculating unit.

3. The system according to claim 1, further comprising a notifying apparatus arranged in the predetermined store or near the predetermined store, wherein
the notification control unit causes the notifying apparatus to perform notification of the free parking available remaining time.

4. The system according to claim 2, further comprising a notifying apparatus arranged in the predetermined store or near the predetermined store, wherein
the notification control unit causes the notifying apparatus to perform notification of the additional purchase amount calculated by the free-period-addable-amount calculating unit.

5. The system according to claim 1, further comprising:
a first identification-information acquiring apparatus configured to acquire the identification information of the user who parks the vehicle in the car park and pass the identification information to the identification-information acquiring unit;
a second identification-information acquiring apparatus arranged in the predetermined store or near the predetermined store and configured to acquire the identification information of the user who inquires about the remaining time of the free parking available period concerning the car park and pass the identification information to the inquiring-user identifying unit; and
a required-time calculating unit configured to calculate time required for movement from the second identification-information acquiring apparatus, which acquires the identification information of the inquiring user, to a parking fee adjustment machine associated with the first identification-information acquiring apparatus that acquires the identification information of the user, whose identification information is acquired by the second identification-information acquiring apparatus, during the parking, wherein
the notification control unit causes the second identification-information acquiring apparatus to notify the required time calculated by the required-time calculating unit.

6. The system according to claim 5, further comprising a parking-position-storage control unit configured to cause the system to store a parking position where the user, whose identification information is acquired by the identification-information acquiring unit, parks the vehicle in the car park in a predetermined storage device in association with the identification information of the user, wherein
the notification control unit causes the second identification-information acquiring apparatus to notify the parking position caused to be stored by the parking-position-storage control unit.

7. A parking fee management supporting method in a parking fee managing system concerning a car park in which a free parking available period is granted according to a purchase amount in a predetermined store, the method comprising:
acquiring identification information of a user who parks a vehicle in the car park;
causing the parking fee managing system to store, in a predetermined storage area, parking start time in the car park by the user, whose identification information is acquired, in association with the identification information of the user;
causing the parking fee managing system to store, in the predetermined storage area, purchase information concerning the purchase amount in the predetermined store by the user, whose identification information is acquired, in association with the identification information of the user;
acquiring identification information of an inquiring user who inquires about a remaining time of the free parking available period concerning the car park;
calculating a free parking available remaining time in the car park in association with the inquiring user, whose identification information is acquired, on the basis of the parking start time caused to be stored in the predetermined storage area and the purchase information caused to be stored in the predetermined storage area; and
causing the parking fee managing system to notify the inquiring user, whose identification information is acquired, of the calculated free parking available remaining time.

8. The method according to claim 7, wherein
the free parking available period is extended by a predetermined additional free period if the purchase amount in the predetermined store during the free parking available period satisfies a predetermined condition, and
the method further comprises:
calculating, on the basis of at least the purchase information caused to be stored in the predetermined storage area, an additional purchase amount necessary for obtaining the predetermined additional free period; and
causing the parking fee managing system to notify the inquiring user, whose identification information is acquired, of the calculated additional purchase amount.

9. The method according to claim 7, further comprising causing a notifying apparatus arranged in the predetermined store or near the predetermined store to perform notification of the free parking available remaining time.

10. The method according to claim 8, further comprising causing a notifying apparatus arranged in the predetermined store or near the predetermined store to perform notification of the calculated additional purchase amount.

11. The method according to claim 7, wherein
the parking fee managing system includes: a first identification-information acquiring apparatus configured to acquire the identification information of the user who parks the vehicle in the car park; and a second identification-information acquiring apparatus arranged in the predetermined store or near the predetermined store and configured to acquire the identification information of the user who inquires about the remaining time of the free parking available period concerning the car park, and
the method further comprises:
calculating time required for movement from the second identification-information acquiring apparatus, which acquires the identification information of the inquiring user, to a parking fee adjustment machine associated with the first identification-information acquiring apparatus that acquires the identification information of the user, whose identification information is acquired by the second identification-information acquiring apparatus, during the parking; and
causing the second identification-information acquiring apparatus to notify the calculated required time.

12. The method according to claim 11, further comprising:
causing the parking fee managing system to store a parking position where the user, whose identification information is acquired, parks the vehicle in the car park in a predetermined storage device in association with the identification information of the user; and
causing the second identification-information acquiring apparatus to notify the parking position caused to be stored in the predetermined storage area.
